(19) United States
(12) Patent Application Publication
(10) Pub. No.: US 2005/0069682 A1
(43) Pub. Date: Mar. 31, 2005

(54) Custom 3-D Milled Object with Vacuum-Molded 2-D Printout Created from a 3-D Camera

(75) Inventor: Tan Tseng, Redwood City, CA (US)

Correspondence Address: STUART T AUVINEN, 429 26TH AVENUE, SANTA CRUZ, CA, 95062-5319, US

(73) Assignee: Tan Tseng, Redwood City, CA (US)

(21) Appl. No.: 10/605,446

(22) Filed: Sep. 30, 2003

(51) Int. Cl. B32B 3/00

(52) U.S. Cl. 428/195.1

(57) ABSTRACT

A 3D copy of a 3D subject is made by combining a 3D custom milled shape and a 2D printed 2D image sheet molded to the contours of the 3D custom milled shape. A 3D camera captures 3D details of the 3D subject and also captures a multi-color 2D image of the 3D subject. The 3D camera outputs a geometry file to a CNC milling machine that cuts a milling blank to make a custom milled shape. The 3D camera also outputs a 2D image file to a personal computer that prints the 2D image onto a plastic sheet. The custom milled shape is placed as a mold on a vacuum-forming machine. The plastic sheet is aligned to the custom milled shape and heat and vacuum pressure applied. The 2D image is molded into the 3D shape of the custom milled shape.

### BACKGROUND OF INVENTION

This invention relates to 3D object capture, and more particularly to capturing 2D and 3D images and fitting 2D details on a 3D object.

Images of people and other 3-dimensional (3D) objects have been captured using traditional 2D digital cameras. More recently, digital cameras have been used to capture 2D images of 3D objects. The digital storage of these digital pictures allows for impressive detail and color to be caught by a digital camera and later printed or viewed.

FIGS. 1A-B show a digital camera that captures a 2D image and a computer and printer for displaying the 2D image. In FIG. 1A, digital camera 12 has a lens that captures light from 3D object 10. The light collected from object 10 is sent to a charge-coupled-device (CCD) or other image sensor within digital camera 12. The 2D surface of the CCD converts the captured light to pixels that represent color and shades at different x,y positions on the surface of the CCD.

The pixels generated by digital camera 12 are stored in a standard format, such as by the Joint-Pictures-Experts-Group (JPEG) or bit map format (BMP). The pixels may be in a pattern such as a Bayer pattern where some x,y positions may have pixels of some colors but not other colors, requiring interpolation to generate the missing colors.

In FIG. 1B, personal computer PC 14 receives a JPEG image file from digital camera 12 of FIG. 1A. A memory card from digital camera 12 can be inserted into a special reader on PC 14, or an interface such as a Universal-Serial-Bus (USB) cable may be used to transfer the digital image file to PC 14. The digital image represented by the JPEG file may be converted to display pixels and displayed on PC 14, or may be converted to printable pixels and printed on printer 16. Printer 16 can output a 2D picture 18 of 3D object 10. While colorful and detailed, 2D picture 18 is still a flat image and thus is not a perfect representation of 3D object 10 as it lacks the third dimension.

FIGS. 2A-B show a 3D camera and a 3D milling machine that generate a 3D replica. In FIG. 2A, 3D camera 20 captures a 3D image of 3D object 10. A variety of technologies can be used by 3D camera 20 to capture not only the 2D image, but also the 3D information of object 10. For example, some 3D cameras may have a mechanical probe that actually touches the surface of 3D object 10. As the probe slides along the surface of 3D object 10, 3D camera 20 records movements of the probe that correspond to 3D features of object 10.

Other technologies for 3D camera 20 may use a laser range-finder to determine distances from 3D camera 20 to locations on the surface of 3D object 10. The range-finder may be scanned across the surfaces of 3D object 10. Another method is to project a grid pattern onto the surface of 3D object 10, and then distortions in the projected grid pattern are visible on the surface of 3D object 10 and captured by 3D camera 20. The grid pattern can have different colors to aid contour identification. A time-varying sinusoidal pattern can also be projected onto 3D object 10 and variations captured by 3D camera 20 at different times. A second 3D camera 20′ may be used for stereoscopic image-capture methods, or 3D camera 20 or object 10 may be moved to capture views from different sides or angles that are later combined into a single 3D model for object 10.

The 3D information can be stored as a contour map of Z or range data in addition to the normal 2D image information captured by a camera. Some standard 3D geometry-file formats exist, such as DXF, VRML, and STL. Various proprietary formats may also be used.

In FIG. 2B, a 3D milling machine reads the geometry file from the 3D camera and mills a 3D shape of the captured object. Various rapid-prototyping systems are available, such as a Computer-Numeric-Control CNC milling machine. Milling machine 24 receives the geometry file captured by 3D camera 20 and converts the geometry file to a series of motions of drill or lathe bit 22. Milling blank 28 is loaded into milling machine 24 and can be moved up, down, left, right, and rotated by turn-table 25 to allow bit 22 to cut at desired locations on milling blank 28. After some time, bit 22 has cut away portions of milling blank 28 to reveal the desired milled shape 26. Milled shape 26 is a representation of 3D object 10 that was captured by 3D camera 20 and described by the geometry file sent to milling machine 24.

While milled shape 26 is a 3-dimensional representation of 3D object 10, it may lack color, texture, and other details of real 3D object 10. For example, milling blank 28 may be a block of wax or soft plastic and may be of uniform color and texture. Then milled shape 26 has the same uniform color and does not have the same colors and textures as 3D object 10.

The color and texture details of 2D picture 18 (FIG. 1B) are lost in order to add the 3D details of milled shape 26. However, 2D picture 18 lacks the depth and shape of milled shape 26. Neither 2D picture 18 nor milled shape 26 satisfyingly copies the color, details, and shapes of 3D object 10.

A 2D sheet containing a photograph or image of a person can be pulled over a generic face mold to give shape to the photograph. See U.S. Pat. No. 5,040,005 by Davidson et al. However, since the generic face mold is not the exact shape of the particular person in the photograph, the molded image can have registration problems, such as the eyes in the picture being stretched over the cheeks. Distortions can occur when the person has a smaller or large face than the generic face mold, or when facial features differ, such as when the person has a large nose or forehead.

What is desired is a more realistic and colorful 3D milled shape. A process to capture 3D and 2D details and use these details to generate a 3D-shaped object copy is desirable.

### BRIEF DESCRIPTION OF DRAWINGS

FIGS. 1A-B show a digital camera that captures a 2D image and a computer and printer for displaying the 2D image.

FIGS. 2A-B show a 3D camera and a 3D milling machine that generate a 3D replica.

FIG. 3 is a diagram highlighting 3D/2D capture, 3D milling, and 2D printing and vacuum forming over the 3D milled shape.

FIG. 4 is a flowchart of an overview of forming a custom 2D-printed 3D-shaped object captured from a 3D camera.

FIG. 5 is a more detailed flowchart of CNC milling.

FIG. 6 is a flowchart of processing and printing the 2D image onto a plastic sheet.

FIG. 7 is a flowchart of the vacuum-forming process to attach the 2D printed sheet to the custom milled 3D shape.

FIGS. 8A-G show vacuum forming the printed 2D image sheet over the custom 3D milled shape.

FIG. 9A shows a flattened 2D image of a 3D face.

FIG. 9B shows the flattened 2D image after enhancement that removes the nostrils of the face.

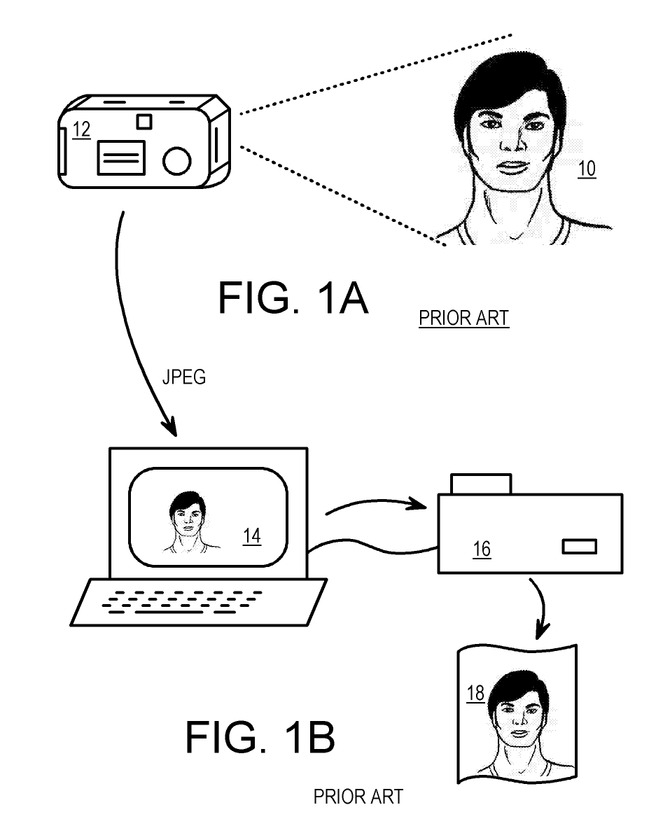

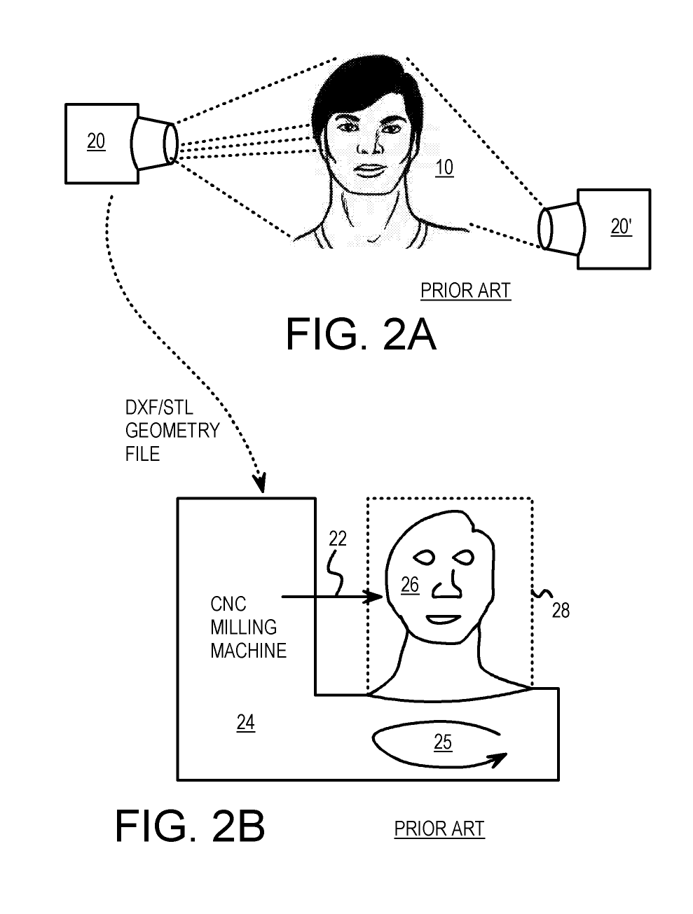

### DETAILED DESCRIPTION

The present invention relates to an improvement in 3D prototyping. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

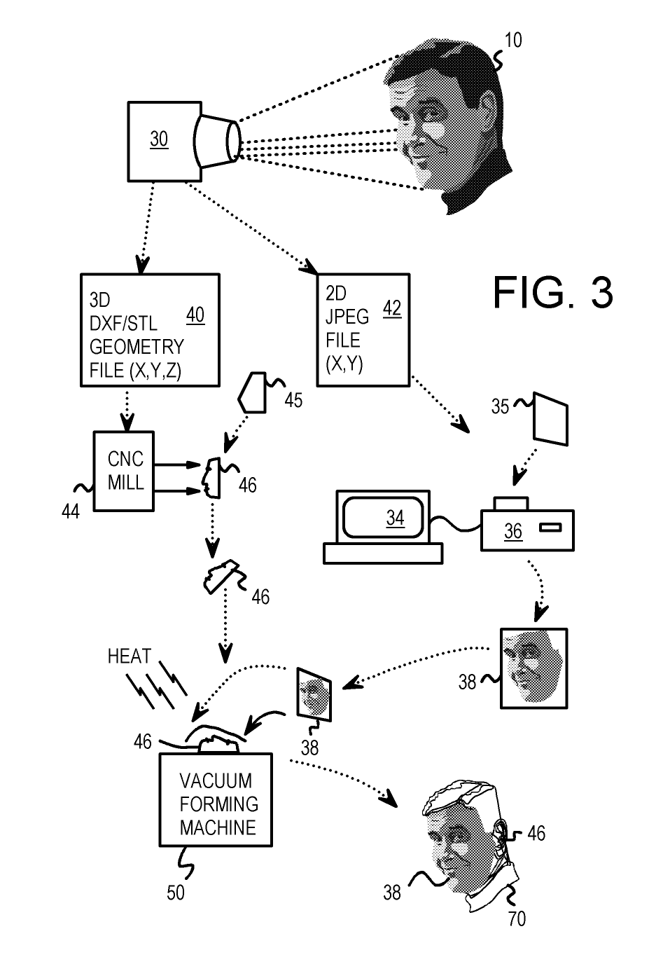

FIG. 3 is a diagram highlighting 3D/2D capture, 3D milling, and 2D printing and vacuum forming over the 3D milled shape. Laser range-finding or other techniques may be used by 3D camera 30 to capture geometry details of 3D object 10. The geometry details captured by 3D camera 30 are loaded into geometry file 40, which may be in a standard format such as DXF, STL, VRML, IGES, etc. Geometry file 40 contains (x,y,z) data for points on the surfaces of 3D object 10 and may be in various formats.

At the same time or about the same time that the X, Y, Z data for geometry file 40 is captured by 3D camera 30, a 2D image is also captured. Ideally, the 2D image is captured through the same lens of 3D camera 30 that the 3D data is captured from to minimize distortions. The laser range-finder may be slightly offset from the image-capturing lens in some embodiments. The 2D image data is loaded into JPEG 2D image file 42. Other formats such as TIFF may be used for 2D image file 42. Color pixel data for (x,y) locations of the flat image seen by the lens of 3D camera 30 are contained 2D image file 42.

Thus 3D camera 30 outputs both geometry file 40 and 2D image file 42. Some commercially available 3D cameras are capable of outputting both files 40, 42, such as the VIVID 700 by Minolta.

Geometry file 40 is sent to 3D milling machine 44, which may be a CNC computer-numerical-controlled machine such as a computer-controlled lathe, drill, etc. Geometry file 40 may first be processed and converted by a computer to generate machine-instruction files that actually control the positioning of the cutting bit and work piece on milling machine 44. Milling blank 45 may be of wax or soft plastic that can be shaped by milling machine 44. Milling blank 45 is loaded onto milling machine 44 and shaped to generate custom milled shape 46 which has the shape of 3D object 10 described by geometry file 40.

The 2D image file 42 is sent to personal computer PC 34. PC 34 generates a printer file of the 2D image that is sent to printer 36. Rather than printing on standard paper, printer 36 is loaded with special heat-formable plastic sheet 35. Polystyrene, polyethylene, or other heat-sensitive plastic sheeting may be used for heat-formable plastic sheet 35. Special coatings may be applied to heat-formable plastic sheet 35 to improve ink adherence, or special inks may be used by printer 36.

Printer 36 generates printed 2D image sheet 38, which has printed on it the 2D image captured by 3D camera 30 as 2D image file 42. Both printed 2D image sheet 38 and custom milled shape 46 are custom representations of 3D object 10.

Printed 2D image sheet 38 is molded to custom milled shape 46 by vacuum forming machine 50. Custom milled shape 46 is loaded onto a vacuum table or mold portion of vacuum forming machine 50 which can have a vacuum applied. Printed 2D image sheet 38 is placed above custom milled shape 46 on vacuum forming machine 50 and heat is applied to printed 2D image sheet 38. The applied heat causes the plastic of printed 2D image sheet 38 to soften, and the vacuum pressure difference pulls the softened plastic of printed 2D image sheet 38 over custom milled shape 46. Printed 2D image sheet 38 conforms to the shape of custom milled shape 46 as the vacuum pulls at the softened plastic.

The molded printed 2D image sheet 38 is allowed to cool and then printed 2D image sheet 38 and custom milled shape 46 are removed from vacuum forming machine 50. Generated object 70 has custom milled shape 46 with printed 2D image sheet 38 formed over some or all of the surfaces. For example, printed 2D image sheet 38 may be formed just over the face area of a person's head while the remaining surfaces of custom milled shape 46 are left un-colored, or additional printed 2D image sheets could be applied to different areas of custom milled shape 46.

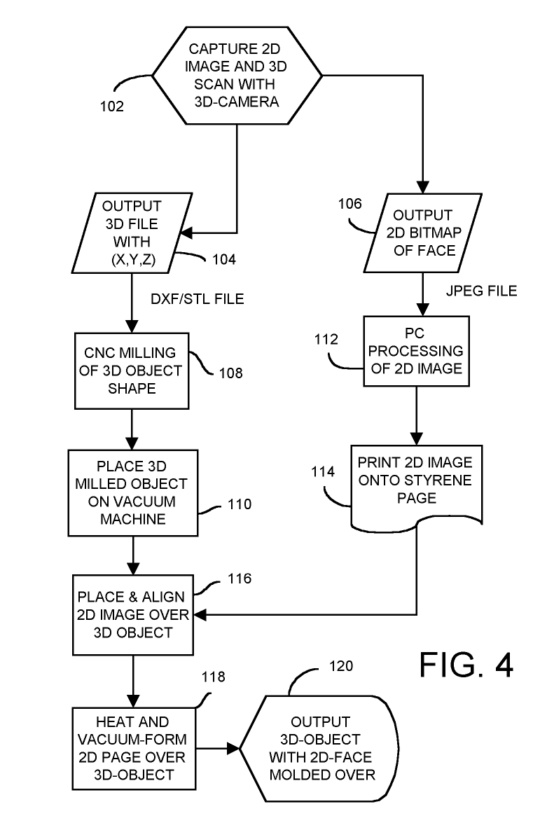

FIG. 4 is a flowchart of an overview of forming a custom 2D-printed 3D-shaped object captured from a 3D camera. A 3D camera captures both the 2D image and 3D geometry from a 3D object, step 102. Some scanning may be performed to determine the geometry data, such as scanning by a laser range-finder or processing of fringe diffraction patterns of a projection on the 3D object.

Two files are generated by the 3D camera: a geometry file indicating x,y,z data and a 2D image file indicating x,y color data. The geometry file is typically X,Y,Z data that corresponds to an industry standard such as DXF of Autocad, IGES, or STL format. The geometry file may be mono-color (black and white or grayscale) while 2D image file contains color information.

The geometry file is output by the 3D camera, step 104, and read by a CNC milling machine. Some pre-processing may be performed by the CNC machine itself or by another computer, such as converting a DXF/STL format of the geometry file into a file of machine-control instructions. The geometry file or machine-instruction file is sent to the CNC milling machine, which cuts a blank to generate the 3D object, step 108. The shaped 3D object represents the object described by the geometry file. This milled 3D object is placed as the mold on a vacuum forming machine, step 110.

The 2D image file is sent to a personal computer or workstation, step 106. The 2D image file may have a standard format such as JPEG, BMP, TIFF, etc. The personal computer processes the 2D image file, step 112, such as by generating a printer file. The processed 2D image file is printed by a printer, step 114. Rather than print onto standard paper, the image is printed onto a heat-formable plastic sheet such as styrene.

The printed 2D image sheet is aligned to the custom milled shape on the vacuum forming machine 50, step 116. For example, the nose or eyes of a person's image on the printed 2D image sheet can be aligned over the nose and eye shapes of the custom milled shape. Heat is applied to the aligned printed 2D image sheet and vacuum is pulled from the custom milled shape by the vacuum forming machine. The printed 2D image sheet is pulled over the custom milled shape as heat and vacuum are applied, step 118. After cooling, the printed 2D image sheet shaped over the custom milled shape are removed as the generated object 120.

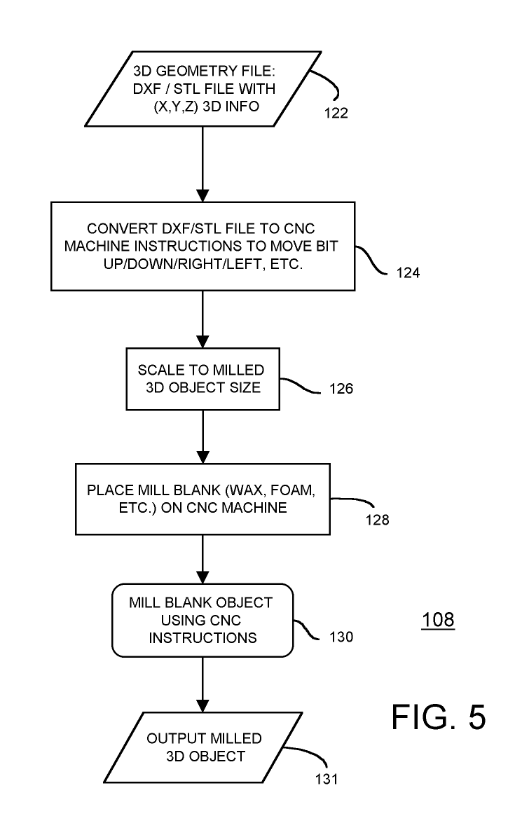

FIG. 5 is a more detailed flowchart of CNC milling. CNC milling step 108 receivers the DXF/STL geometry file, step 122. The geometry file is compiled into machine instructions or industry NC numerical-code file, step 124, which control movement and operation of the cutting instruments of the CNC milling machine. The size of the 3D object may be scaled, step 126, to fit the shape and size of the milling blank. Such scaling could be performed before or after conversion of the DXF file.

The milling blank is placed on the CNC machine, step 128. The milling blank may be wood, plastic, wax, foam, or other millable material that can be cut by the CNC milling machine. The converted geometry file of machine instructions is then executed by the CNC milling machine, causing the milling machine to cut the milling blank according to the instructions, step 130. The milling machine may pause part-way through the program to allow a human operator to change cutting instruments or flip over the partially-milled blank. The final milled 3D object 131 can be removed once execution is complete.

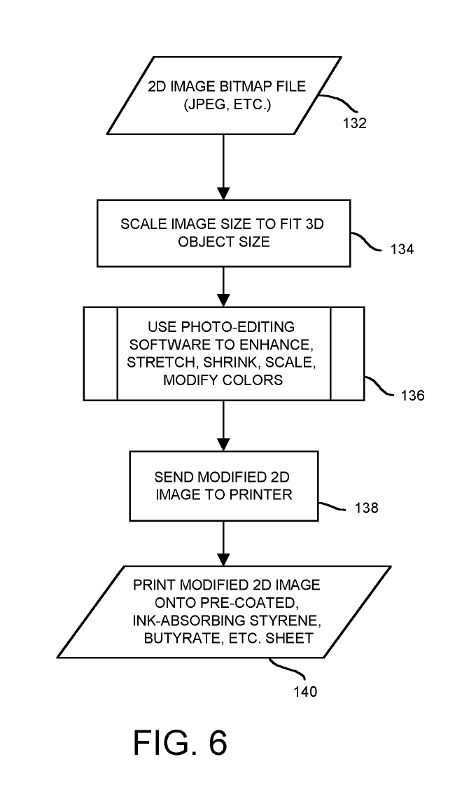

FIG. 6 is a flowchart of processing and printing the 2D image onto a plastic sheet. The 2D image file is received from the 3D camera, step 132. The image is scaled to fit the object size, step 134. This size corresponds to the size of the custom milled shape of step 126 in FIG. 5, or a portion of the size, such as a face portion of a head shape.

Commercially available photo-editing software may also be used to enhance the 2D image, step 136. Colors can be enhanced or the image can be pre-distorted to compensate for the molding processes so that the final shaped 2D image better fits the custom milled shape. Other processing such as red-eye reduction may be performed.

The optionally-enhanced 2D image is sent to the printer, step 138. The PC may convert the JPEG or TIFF file into a printer-specific format. The printer then prints the image onto a thermo-formable or heat-formable plastic sheet, step 140. The printer may be loaded with a polyethylene, butyrate, styrene, glycol-modified polyethylene terephthalate (PETG), or other thermo-formable sheet. The plastic sheet may be pre-coated to improve ink absorption.

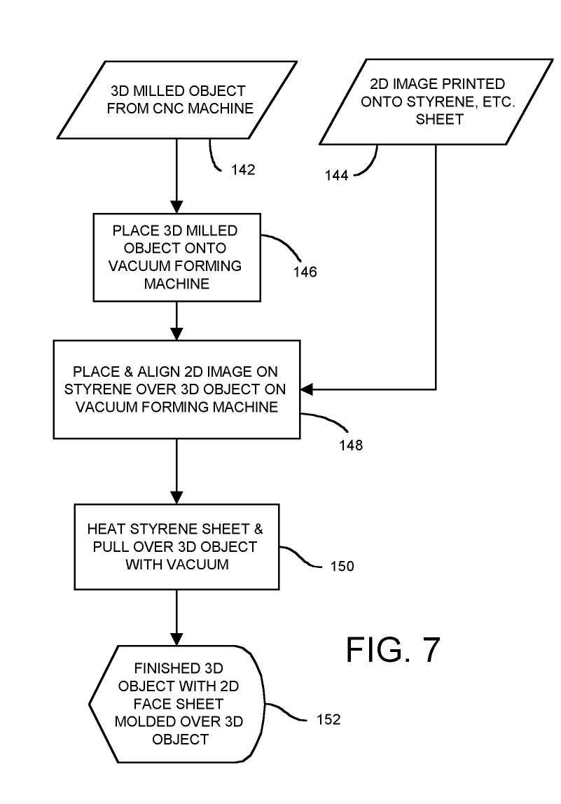

FIG. 7 is a flowchart of the vacuum-forming process to attach the 2D printed sheet to the custom milled 3D shape. The custom milled 3D shape 142 from the CNC milling machine is placed as the mold on a vacuum table portion of the vacuum forming machine, step 146. The printed 2D image sheet 144 is placed over and aligned to the custom milled shape, step 148. Heat is applied to the printed 2D image sheet to allow it to bend over the custom milled shape, step 150, as vacuum is applied to the custom milled shape, causing the printed 2D image sheet to bend and conform to the custom milled shape.

Once the printed 2D image sheet has been shaped and cooled, the custom milled shape with the printed 2D image sheet formed over it can be removed as 3D object 152 with the molded 2D sheet over it. The molded sheet could be detached from the custom milled shape and the custom milled shape discarded, or the two parts could remain together.

The color detail on the formed and printed 2D image sheet vastly improves the appearance of the mono-color custom milled shape. Shaping of the printed 2D image sheet improves the realism of the printed image.

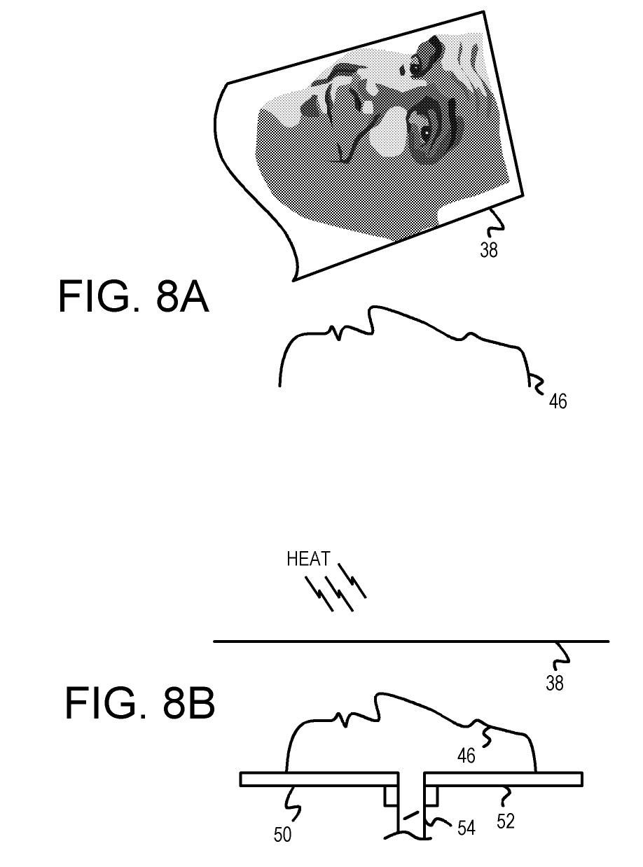

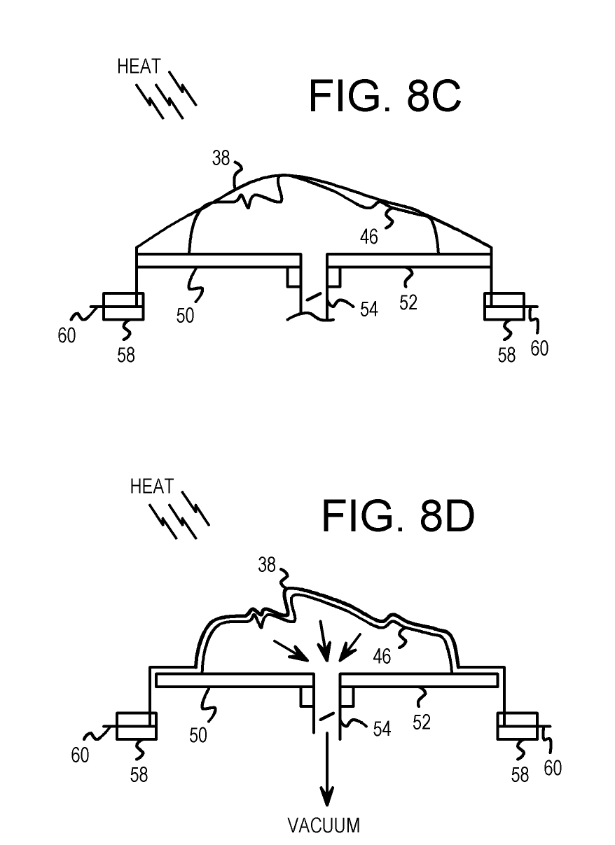

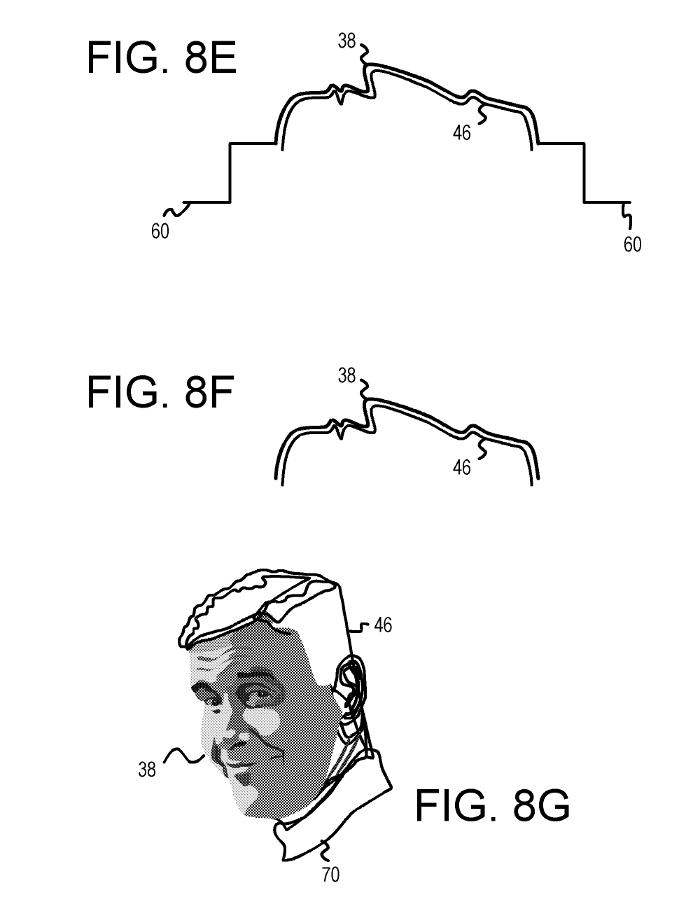

FIGS. 8A-G show vacuum forming the printed 2D image sheet over the custom 3D milled shape. In FIG. 8A printed 2D image sheet 38 is received from the PC printer while custom 3D milled shape 46 is received from the CNC milling machine. Both are custom made for the particular image/object. Custom milled shape 46 may be a solid object or may be a hollow object. Two or more pieces may be separately milled on the CNC milling machine and then joined together.

In FIG. 8B custom milled shape 46 is placed on vacuum table 52 of vacuum forming machine 50. A vacuum can be pulled from custom milled shape 46 through vent 54. Custom milled shape 46 can be fitted to table 52 by a variety of ways such as using clamps, clips, paste, gel, etc. Printed 2D image sheet 38 is placed over custom milled shape 46 and aligned.

In FIG. 8C the ends 60 of printed 2D image sheet 38 are pulled down and clamped with sheet clamps 58. Heat may be applied before printed 2D image sheet 38 is clamped or not until after clamping. Printed 2D image sheet 38 is pulled over custom milled shape 46. Table 52 can be lifted to allow custom milled shape 46 to touch printed 2D image sheet 38, or clamps 58 can be lowered.

In FIG. 8D a vacuum is pulled from vent 54, causing air to be pulled through custom milled shape 46. Small holes or pores in custom milled shape 46 allow the vacuum's pressure difference to pull at printed 2D image sheet 38. Since printed 2D image sheet 38 is also heated, it is easily deformable. However, custom milled shape 46 is made of higher-deformable-temperature material and holds its shape. Printed 2D image sheet 38 is pulled by the vacuum to conform to the shape of custom milled shape 46.

In FIG. 8E the heat and vacuum have been removed and printed 2D image sheet 38 is allowed time to cool. Ends 60 of printed 2D image sheet 38 are removed from clamps 58. Custom milled shape 46 and printed 2D image sheet 38 are removed from vacuum forming machine 50. Printed 2D image sheet 38 retains the shape of custom milled shape 46.

In FIG. 8F ends 60 are trimmed or cut off of printed 2D image sheet 38, revealing printed 2D image sheet 38 formed over custom milled shape 46. Custom milled shape 46 can be hollow as shown, or can be solid and kept as a part of as generated object 70 in FIG. 8G along with printed 2D image sheet 38 which provides surface color and detail. Printed 2D image sheet 38 could also be removed from custom milled shape 46 and would retain its shape. Other printed 2D image sheets could be attached to custom milled shape 46 or to printed 2D image sheet 38 to enlarge generated object 70.

Many 3D cameras are capable of capturing the 2D image of a 3D object and of flattening the 3D image into 2D image, such as how a flattened projection map of North America can be made from a 3D globe. A flattened 2D image of a person's head might include both the right and left sides by the ears, even though these right and left sides are opposite each other. Various 3D software tools such as the 3DS Max software by Discreet (now part of Autodesk Corp.) are capable of rendering a 3D object image into a flattened 2D image.

It is very difficult to form a good likeness of the original nose and nostrils onto the proper 3D position. In one method, the nostrils are used with software such as Photoshop to clone the skin color around the nose. The 2D image is also scaled to fit the 3D mold. In particular, the eye and mouth sizes can be scaled to fit the size required for the 3D mold. Color enhancement can be applied to the color of the skin, eyes, and mouth to enhance the color, such as to make it lighter, darker or a better hue.

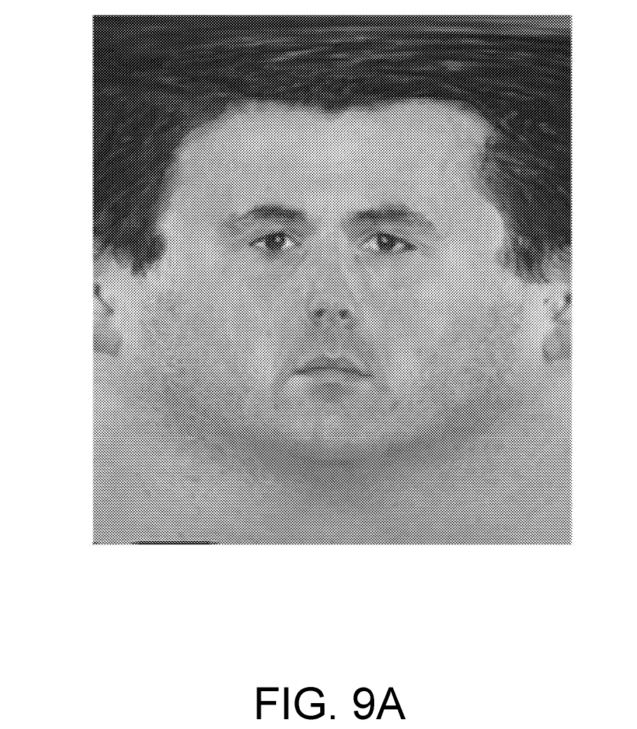

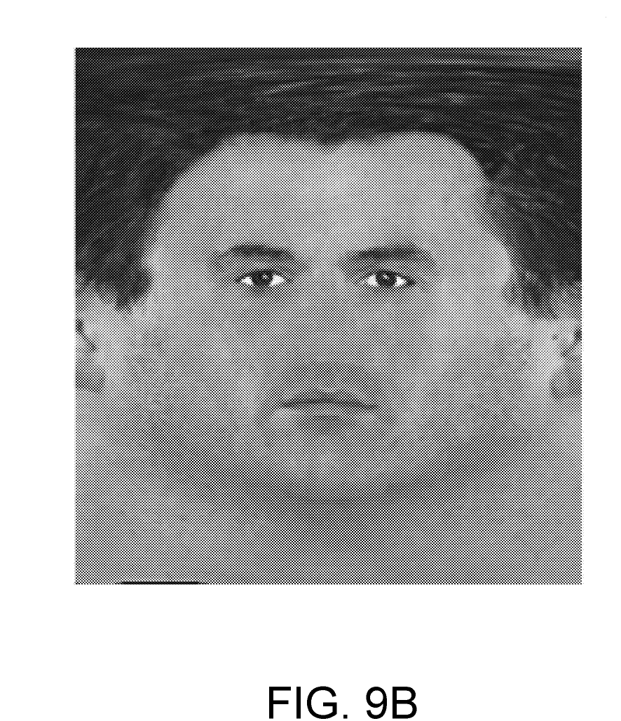

It is possible not to use a flattened 2D image from a 3D camera and still produce a similar result. A regular 2D image from an ordinary 2D camera can be stretched with the same skin color in all directions (top, down, left, right, up, down, etc.) while keeping the eye and mouth position and size the same as the mold's eye and mouth. The nostrils can be masked off with the surrounding nose color or skin color. FIG. 9A shows a flattened 2D image of a 3D face. FIG. 9B shows the flattened 2D image after enhancements. Enhancements can include cleaning up the eyes, replacing the eyes and mouth with a regular 2D eyes and mouth, removing the nostrils from the face, and cloning the nose and nostrils with skin color surrounding the nose.

Alternate Embodiments

Several other embodiments are contemplated by the inventor. The vacuum forming machine and CNC milling machine can have a variety of configurations, orientations, options, and variations. For example, the custom milled shape can be raised to touch the printed 2D image sheet or the sheet can be lowered or pulled over the custom milled shape. The CNC machine can use a variety of cutting instruments and can move the work piece in a variety of ways. Some human intervention may be needed, such as to flip over a work piece to allow the CNC machine to shape a reverse side of the work piece.

Different materials may be used for the printed 2D image sheet and for the custom milled shape. The 2D image may be printed onto a decal or stick-on material that is later attached to the plastic sheet for heat-molding. The printer could be an ink-jet printer, a laser printer, or some other kind of printer.

Heat can be applied in a variety of ways such as with a heater, heat gun, heat lamp, or a convective or radiant heater could be used to either soften or harden and cure the plastic sheet. Other post-processing steps could be performed, and other steps could be added to the flow. Directions such as over, under, etc. are relative and can have different meanings depending on the relative positions of the custom milled shape and the printed 2D image sheet in the vacuum forming machine, for example. The printed 2D image sheet that is “over” the custom milled shape could physically be “under” the custom milled shape in some machines that flip the orientation over. Thus such directional terms are relative.

A hollow, concave (female) mold may be used for vacuum forming rather than the convex (male) mold. A portion of the 3D object may be milled rather than the whole 3D object. For example a face mask rather than a whole head could be milled. Formed printed 2D image sheet 38 could be removed from custom milled shape 46 and would still have the custom shape from custom milled shape 46.

Several printed 2D image sheets 38 could be separately formed and attached to separate custom milled shapes 46 that are later fitted together. Likewise, several printed 2D image sheets 38 could be separately formed and stitched or spliced together. For example, the back of a person's head could be separately printed on the printed 2D image sheet 38 and formed over a back-of-head custom milled shape 46 and then joined with a face printed 2D image sheet 38 formed over a face custom milled shape 46.

The eyeballs of the formed 2D image can be carved out and replaced with synthetic solid round eyeballs to make the formed 2D image more realistic. Another alternative is to add tiny synthetic hair to replace the hair and eyebrow.

The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. 37 C.F.R. § 1.72(b). Any advantages and benefits described may not apply to all embodiments of the invention. When the word “means” is recited in a claim element, Applicant intends for the claim element to fall under 35 USC § 112, paragraph 6. Often a label of one or more words precedes the word “means”. The word or words preceding the word “means” is a label intended to ease referencing of claims elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word means are not intended to fall under 35 USC §112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A process for generating a 3-dimensional (3D) object copy with 2-dimensional (2D) details comprising:
capturing 3D details of a 3D subject;
loading the 3D details into a geometry file;
capturing a 2D image of the 3D subject to generate a 2D image file;
transferring the 2D image file to an image-processing computer;
generating a printer file from the 2D image file and sending the printer file to a printer;
transferring a 2D image represented by the printer file onto a plastic sheet to generate a printed 2D image sheet;
transferring the geometry file to a 3D milling machine;
inserting a milling blank into the 3D milling machine;
cutting the milling blank on the 3D milling machine according to the 3D details from the geometry file to generate a custom milled shape;
placing the custom milled shape as a mold on a vacuum forming machine; and
aligning, heating, and vacuum-forming the printed 2D image sheet using the custom milled shape to re-form the printed 2D image sheet to contours of the custom milled shape to form the 3D object copy having 2D detail from the printed 2D image sheet after molding,
whereby the 3D object copy has 2D details from the 2D image file but a shape described by the geometry file.

2. A product produced by the process of claim 1, wherein the product is the 3D object copy that comprises the printed 2D image sheet after molding and separated from the custom milled shape or the 3D object copy comprises the printed 2D image sheet after molding and attached to the custom milled shape.

3. The process of claim 1 further comprising:
separating the printed 2D image sheet from the custom milled shape after molding by the vacuum forming machine;
whereby the printed 2D image sheet is molded into a 3D shape by the custom milled shape.

4. The process of claim 3 wherein the printed 2D image sheet is an image of a person's face;
wherein the custom milled shape is a 3D face or a person's head.

5. The process of claim 1 wherein the printer is a color printer but the custom milled shape is mono-color; whereby color details are added to the 3D object copy by the printed 2D image sheet and shape details are formed from the custom milled shape.

6. The process of claim 5 wherein capturing 3D details of the 3D subject and capturing the 2D image of the 3D subject to generate the 2D image file comprise image capture and 3D-detail capture by a 3D camera,
whereby the 3D camera generates both the geometry file and the 2D image file.

7. The process of claim 6 wherein capturing 3D details of the 3D subject with the 3D camera and capturing the 2D image of the 3D subject comprise using a single lens of the 3D camera to capture both the 2D image and the 3D details,
whereby 3D and 2D information is captured through a same lens.

8. The process of claim 1 wherein the image-processing computer is a personal computer, a laptop computer, or a workstation.

9. The process of claim 8 further comprising:
editing the 2D image file using photo-editing software on the personal computer, the laptop computer, or the workstation.

10. The process of claim 8 further comprising:
removing an image of human nostrils from the 2D image file by covering the image of human nostrils with a skin color from the 2D image file.

11. The process of claim 1 wherein transferring the geometry file to a 3D milling machine comprises first transferring the geometry file to a pre-processing computer that generates a machine-instruction file from the geometry file, then sending the machine-instruction file to the 3D milling machine,
whereby the geometry file is pre-processed for the 3D milling machine.

12. The process of claim 1 wherein the plastic sheet is a heat-formable plastic sheet.

13. The process of claim 12 wherein the plastic sheet is styrene, polyethylene, butyrate, glycol-modified polyethylene terephthalate (PETG), or other heat-formable sheet.

14. The process of claim 12 wherein the plastic sheet is pre-coated to improve ink absorption from the printer.

15. The process of claim 1 wherein transferring the 2D image onto the plastic sheet comprises directly printing the 2D image onto the plastic sheet that is a pre-coated ink-absorption plastic sheet.

16. The process of claim 1 wherein transferring the 2D image onto the plastic sheet comprises directly printing the 2D image onto a decal sheet to generate a printed decal and transferring the printed decal to the plastic sheet to generate the printed 2D image sheet.

17. The process of claim 1 wherein the custom milled shape is a male or a female molded shape.

18. The process of claim 17 wherein the custom milled shape is an initial shape that is re-molded with other materials to form a final custom milled shape before vacuum forming.

19. The process of claim 1 wherein aligning, heating, and vacuum-forming the printed 2D image sheet comprises heating a portion of the printed 2D image sheet.

20. The process of claim 1 wherein aligning, heating, and vacuum-forming the printed 2D image sheet comprises heating the printed 2D image sheet before or after alignment.

21. A generated three-dimensional 3D object with a formed color-detail sheet comprising:
a custom milled shape having been make by milling in three dimensions a milling blank according to 3D details from a geometry file captured by a 3D camera of a subject; and
a molded printed 2D image sheet, molded and affixed to a contoured surface of the custom milled shape, the molded printed 2D image sheet being molded to fit contours of the custom milled shape by molding a flat printed 2D image sheet that has a 2D image of the subject printed thereon,
whereby the generated 3D object is generated from the 3D details of the subject from the geometry file and from the 2D image of the subject printed on the molded printed 2D image sheet.

22. The generated 3D object of claim 21 wherein the 2D image is also captured by the 3D camera that captures the geometry file.

23. The generated 3D object of claim 21 wherein the custom milled shape is mono-color while the 2D image printed on the molded printed 2D image sheet is multi-color.

24. The generated 3D object of claim 23 wherein the custom milled shape comprises at least two separately-milled portions and two molded printed 2D image sheets that are joined together to produce the generated 3D object.

25. The generated 3D object of claim 21 wherein the custom milled shape is milled by a milling machine that is computer-controlled to cut the milling blank according to the 3D details from the geometry file.

26. A method comprising:
capturing 3-dimensional (3D) details of a 3D subject, the 3D details being mono-color;
loading the 3D details into a geometry file;
capturing a 2D image of the 3D subject to generate a 2D image file, the 2D image file being multi-color;
transferring the 2D image file to an image-processing computer;
printing a 2D image represented by the 2D image file onto a plastic sheet to generate a printed 2D image sheet;
transferring the geometry file to a 3D milling machine;
inserting a milling blank into the 3D milling machine;
cutting the milling blank on the 3D milling machine according to the 3D details from the geometry file to generate a custom milled shape;
placing the custom milled shape as a mold on a vacuum forming machine;
aligning the printed 2D image sheet over the custom milled shape in the vacuum forming machine; and
molding the printed 2D image sheet in the vacuum forming machine by heating the printed 2D image sheet and pulling a vacuum through the custom milled shape to re-form the printed 2D image sheet to contours of the custom milled shape to form a 3D object copy of the 3D subject, the 3D object copy having 2D detail from the printed 2D image sheet after molding,
whereby the 3D object copy has 2D details from the 2D image file but a shape described by the geometry file.

27. A product made by the method of claim 26, wherein the product is a 3D object copy that comprises the printed 2D image sheet after molding and separated from the custom milled shape or the 3D object copy comprises the printed 2D image sheet after molding and attached to the custom milled shape.
